(19) United States
(12) Patent Application Publication
(10) Pub. No.: US 2013/0067145 A1
(43) Pub. Date: Mar. 14, 2013

(54) MEMORY DEVICE, MEMORY SYSTEM, AND METHOD OF STORING DATA USING THE SAME

(71) Applicants: Byoung-Sul Kim, Suwon-si (KR); Myong-Jae Kim, Suwon-si (KR); Woo-Il Kim, Yongin-si (KR)

(72) Inventors: Byoung-Sul Kim, Suwon-si (KR); Myong-Jae Kim, Suwon-si (KR); Woo-Il Kim, Yongin-si (KR)

(21) Appl. No.: 13/592,717

(22) Filed: Aug. 23, 2012

(30) Foreign Application Priority Data
Sep. 9, 2011 (KR) 10-2011-0091839

(51) Int. Cl. G06F 12/00

(52) U.S. Cl. 711/103; 711/161; 711/E12.008

(57) ABSTRACT

Provided is a memory device configured to store data having a first characteristic and a second characteristic in a memory region optimized to store data having the first characteristic and the second characteristic. The memory device includes a plurality of memory regions and a region determination unit configured to receive data, select a memory region appropriate for storing the received data, and store the data in the selected memory region. Correspondingly, performance degradation of the memory device may be prevented.

### CROSS-REFERENCE TO RELATED APPLICATION

This U.S. non-provisional patent application claims priority under 35 U.S.C. §119 to Korean Patent Application No. 10-2011-0091839 filed on Sep. 9, 2011, the entire contents of which is hereby incorporated by reference.

### BACKGROUND

A memory device, such as an embedded multimedia card (eMMC), has been used in host apparatuses, such as smart phones and portable phones.

During storage of sequential data of a relatively large memory size, which is generated to store moving-image files, in the memory device, random data (e.g., small data and meta data) generated due to multitasking operations may be frequently stored.

Embodiments of the disclosure relate to a memory device, and more particularly, to a memory device configured to store the corresponding data in a memory region whose storage function is optimized according to the type of data to be stored, out of a plurality of memory regions.

### SUMMARY

Embodiments of the disclosure provide a memory device configured to store the corresponding data in a memory region whose storage performance is optimized according to the type of data to be stored.

In one embodiment, a method of storing data in a memory device comprises receiving information comprising a command, an address, and data from an external source, the information having a first characteristic and at least a second characteristic; selecting one of a plurality of memory regions for storing the received data, wherein the selecting is responsive to a determination that the information has the first characteristic and the second characteristic; and storing the received data in the selected memory region.

In one embodiment, a memory device comprises a controller configured to receive information comprising a command, an address, and data from an external source, the information having a first characteristic and at least a second characteristic; a plurality of memory regions configured to store the data of the information, one or more of the plurality of memory regions being different from one or more of the other memory regions; wherein the controller is further configured to select one of the plurality of memory regions for storing the received data responsive to a determination that the information has the first characteristic and the second characteristic.

In one embodiment, a method of storing data in a memory device comprises receiving information comprising a command, an address, and data, the information having a first characteristic and at least a second characteristic; determining, from the address of the information, at least one of the first characteristic and second characteristic of the data; selecting one of a plurality of memory regions of the memory device for storing the received data, wherein the selecting is responsive to the determination that the information has at least one of the first characteristic and the second characteristic; and storing the data in the selected memory region.

### BRIEF DESCRIPTION OF THE DRAWINGS

The above and other aspects and features of the disclosure will become apparent by describing in detail exemplary embodiments thereof with reference to the attached drawings, in which:

FIG. 1 is a block construction diagram of a memory device according to some embodiments;

FIG. 2 is a block construction diagram of a memory device according to some embodiments;

FIG. 3 is a diagram for explaining the distinctions between sector addresses according to characteristics of data according to some embodiments;

FIGS. 4A-4E are diagrams for explaining an example of an operation of selecting a memory region using an address in a memory region selection unit according to some embodiments;

FIGS. 5A and 5B are diagrams for explaining another example of an operation of selecting a memory region using a address in a memory region selection unit according to some embodiments;

FIG. 6 is a block construction diagram of a memory system according to some embodiments;

FIG. 7 is a block construction diagram of a memory system according to some embodiments;

FIG. 8 is a flowchart illustrating a method of storing data in a memory region optimized to store specific data, according to some embodiments; and

FIG. 9 is a flowchart illustrating a method of storing data in a memory region optimized to store specific data according to some embodiments.

### DETAILED DESCRIPTION OF THE EMBODIMENTS

Various example embodiments will now be described more fully hereinafter with reference to the accompanying drawings, in which exemplary embodiments are shown. The present invention may, however, be embodied in many different forms and should not be construed as limited to the example embodiments set forth herein. That is, these example embodiments are just that—examples—and many implementations and variations are possible that do not require the various details herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention. In the drawings, the sizes and relative size of layers and regions may be exaggerated for clarity. Like numerals refer to like elements throughout.

It will be also understood that although the terms first, second, third etc. may be used herein to describe various elements, components, regions, layers and/or sections, these elements, components, regions, layers, and/or sections should not be limited by these terms. Unless otherwise indicated, these terms are only used to distinguish one element, component, region, layer, or section from another element, components, region, layer, or section. Thus, a first element, components, region, layer, or section in some embodiments could be termed a second element, components, region, layer, or section in other embodiments, and, similarly, a second element, components, region, layer, or section could be termed a first element, components, region, layer, or section without departing from the teachings of the disclosure. Exemplary embodiments explained and illustrated herein may include their complementary counterparts.

The terminology used herein is for the purpose of describing particular embodiments only and is not intended to limit the invention. As used herein, the singular terms “a,” “an” and “the” should not exclude the plural forms as well, unless the context clearly indicates otherwise. As used herein, the term “and/or” includes any and all combinations of one or more of the associated listed items. It will be understood that when an element or a layer is referred to as being “on,” “connected to” or “coupled to” another element or layer, it may be directly on, connected to, or coupled to the other element or layer or intervening elements or layers may be present. In contrast, when an element is referred to as being “directly on,” “directly connected to” or “directly coupled to” another element or layer, there are no intervening elements or layers present. Other words used to describe the relationship between elements or layers should be interpreted in a like fashion (e.g., “between” versus “directly between;” “adjacent” versus “directly adjacent,” etc.).

It will be further understood that the terms “comprises”, “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof.

Locational terms, such as “beneath,” “below,” “lower,” “above,” “upper” and the like, may be used herein for ease of description to describe one element or feature's relationship to another element(s) or feature(s) as illustrated in the figures. It will be understood that the locational terms may be relative to a device and are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the locational descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application and will not be interpreted in an idealized or overly formal sense unless expressly so defined herein.

Hereinafter, example embodiments will be explained in detail with reference to the accompanying drawings.

A memory device, such as an embedded multimedia card (eMMC), has been used in host apparatuses, such as smart phones and portable phones.

During storage of sequential data of a relatively large memory size, which is generated to store moving-image files, in the memory device, random data (e.g., small data and meta data) generated due to multitasking operations may be frequently stored.

Since there are differences in data size and characteristics between the sequential data and the random data, when a controller of the memory device stores data having different storage characteristics and the memory controller uses specific firmware directed to data having the different storage characteristics, an operation speed may be reduced.

Some attempts have been made to improve performance using channel and way operations to solve the above-described problems. In practice it may be difficult to maximize performance of both a random access and a sequential access due to a tradeoff in performance between the random access and the sequential access.

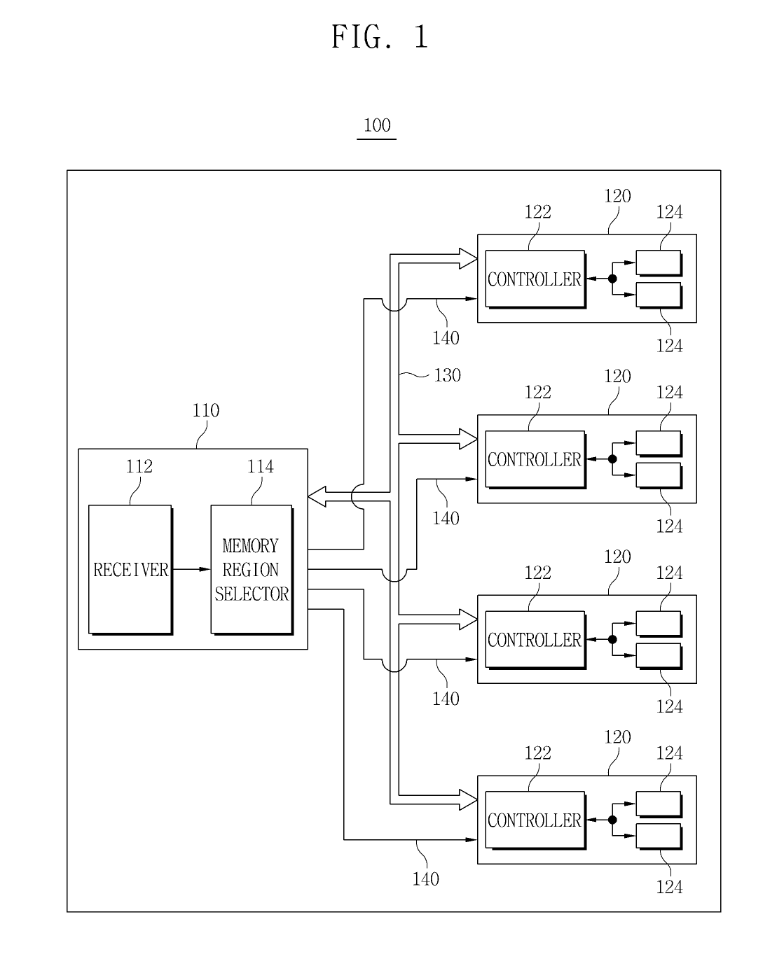

FIG. 1 is a block construction diagram of a memory device according to embodiments of the disclosure.

A memory device 100 may include a region determination unit 110, a plurality of memory regions 120, a common signal line 130, and discrete enable signal lines 140.

The region determination unit 110 may externally receive data storage-related signals, such as data, addresses, and commands, select a memory region appropriate for storing the received data out of the plurality of memory regions 120, and store the received data in the selected memory region. The region determination unit 110 may be a controller or may be another component including circuitry, storage, signal processing and/or I/O capabilities that is configured to receive data-storage related signals, perform some internal processing, and send data-storage related signals. In some embodiments, the host determines a region address for data to be stored in the memory device 100 based on a predetermined set of characteristics of the data to be stored and the memory regions (or types of memory regions) available in the memory device 100. The host then sends the data, command, and region address to the memory device 100. The region determination unit 110 may also be aware of the predetermined set of characteristics and the memory regions (or types of memory regions) available in the memory device 100.

In some embodiments, the region determination unit 110 may receive a region address from the host indicating the characteristics of the data to be stored and may select a memory region optimized over the characteristics of the received data. For example, the region determination unit 110 may include a storage including memory region data regarding each memory region (or the types of memory regions and which memory regions are of which type), and the characteristics over which each memory region (or memory region type) are optimized. A memory region may be optimized over a characteristic of data by being optimized to store data that has that characteristic. For example, a memory region may be optimized over a characteristic of type of data, and may be optimized to store sequential data. In another example, a memory region may be optimized over a characteristic of type of data, and may be optimized to store random data. In some embodiments, a memory region may be optimized over a characteristic of data in relation to the other memory regions available. For example, a memory region may not be optimal for storing sequential data, but may be better store sequential data than the other types of memory region in the memory device 100. The memory region may be optimized (in relation to the other memory regions available in the memory device 100) to store data with one or more characteristics. The region determination unit 110 may receive a region address and select a memory region in which to store the received data based on the memory region data and the region address. In these embodiments, the memory device 100 stores the data in a memory region optimized to store the received data based on the region address.

In some embodiments, the region determination unit 110 may receive a region address from the host indicating a specific memory region in which to store the data. For example, the region determination unit 110 may include circuitry or storage including information regarding the association between the region address and each memory region (or type of memory region). The region determination unit 110 may receive a region address and select a memory region in which to store the received data after internal processing (i.e. after processing the address via circuitry, based on the storage data, etc.). Based on the received region address, the region determination unit 110 may send data-related storage signals and a discrete enable signal to the memory region indicated in the region address. In these embodiments, the memory device 100 stores the data in a memory region optimized to store the received data based on the region address.

In some embodiments, the region determination unit 110 may receive a region address from the host indicating a specific memory region in which to store the data. In these embodiments, the memory regions may have logical address spaces with logical address mirroring the sector addresses at which the received data is stored externally or may have an additional address associated with each physical address in the memory region that mirrors the sector addresses at which the received data is stored externally. The region determination unit 110 may receive a region address and select a memory region based on the region address. In these embodiments, the region address may be the external sector address of the received data. The region determination unit 110 may select a memory region to store the received data based on a match or association of the region address (e.g. the external sector address of the received data). For example, a logical or physical address for the memory region may match with the received region address. In another example, a memory region may indicate that it stores data from a specific range of external sector addresses, and the region address falls within that range of external sector addresses. In these embodiments, the memory device 100 stores the data in a memory region with the associated or matched region address.

A receiver 112 may externally receive the data storage-related signals, such as the data, the addresses, and the commands.

A memory region selector 114 may analyze a received region address, select a memory region appropriate for storing data corresponding to the received region address, selectively transmit an enable signal through the enable signal line 140 corresponding to the selected memory region, and transmit the data, the addresses, and the commands through the common signal line 130 to the plurality of memory regions 120. In some embodiments, the region address is an address that indicates at which memory region (or which type of memory region) the received data is to be stored.

The selected memory region 120, which receives the enable signal through the corresponding enable signal line 140, may store the data using the data storage-related signals, such as the data, the addresses, and the commands, which is transmitted through the common signal line 130.

Each of the plurality of memory regions 120 may include a controller 122 and a memory cell array 124. The controller 122 may receive the data storage-related signals, such as the data, the addresses, and the commands and generate a control signal required to store the data. The controller 122 may also determine and/or indicate the physical addresses of the memory cell array 124 at which the received data is to be stored. The memory cell array 124 may store the data in response to the control signal generated by the controller 122.

Each of the plurality of memory regions 120 may include firmware (i.e., as part of the controller 122) and/or a memory cell array 124 optimized to process data according to the size and/or the type of data to be processed thereby. For example, one memory region may include firmware and a memory cell array optimized to process 4 KB random data, while another memory region may include firmware and/or a memory cell array optimized to process 512 KB sequential data.

In some embodiments, each of the plurality of memory regions 120 may include firmware (i.e. as part of the controller 122) and/or a memory cell array 124 optimized to process data according to the type of a file system (e.g., a virtual file allocation table (VFAT) or a robust file system (RFS)) by which the data to be stored is processed. In some examples, the memory regions 120 may be optimized to store one of random data from a VFAT file system, random data from a RFS file system, sequential data from a VFAT file system, sequential data from a RFS file system, and so forth.

The firmware may include components appropriate to store data with characteristics that the memory region is optimized to store. In some embodiments, in a memory region, the firmware may include a flash translation layer (FTL). In some embodiments, the firmware in the controller 122 may determine, from the received region address from the memory region selector 114, a physical address, and the received data may be stored at that physical address in the selected memory region.

In some embodiments, the data-related storage signals may include the received region address and may also include a logical address relating to the physical address at which the data is to be stored in a memory region. In these embodiments, the received region address may indicate at which memory region the received data should be stored, and the firmware will translate the logical address to determine at which physical address(es) in the indicated memory region the data should be stored. In some of these embodiments, the physical addresses and/or the physical address space of one or more of the plurality of memory regions may overlap. For example, in order to determine at which physical address in which memory region to store received data, an analysis of the received region address and a logical address may be helpful. The controller 122 or the region determination unit 110 may conduct that analysis.

In some embodiments, the memory cell array may be a NAND memory. The memory cell array may be another type of non-volatile memory as well. For example, a single-level-cell (SLC)-type NAND memory configuration with a high data processing rate or a multi-level-cell (MLC)-type NAND memory configuration appropriate for storing mass data may be selected according to the type of data. The type of memory cell array is not limited to the examples described herein.

The plurality of memory regions 120 may include at least one memory region configured to store random data and at least one memory region configured to store sequential data.

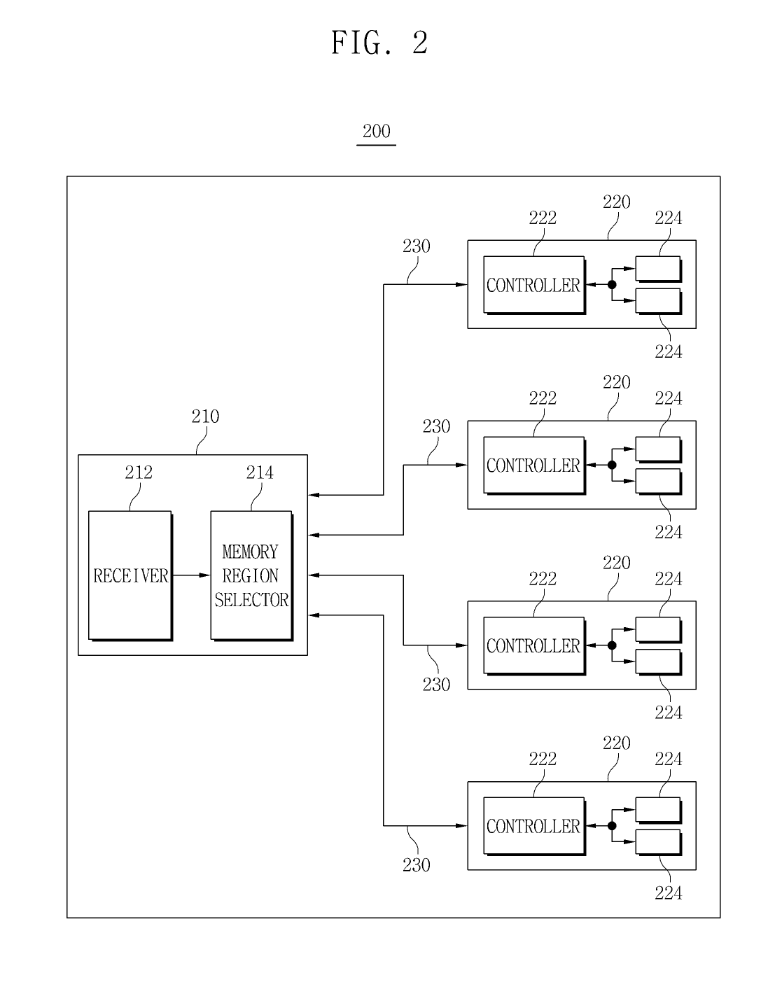

FIG. 2 is a block construction diagram of a memory device according to other embodiments of the disclosure.

A memory device 200 may include a region determination unit 210, a plurality of memory regions 220, and discrete signal lines 230.

The region determination unit 210 may externally receive data storage-related signals, such as data, addresses, and commands, select a memory region appropriate for storing the received data out of the plurality of memory regions 220, and send the appropriate signals and received data via a corresponding discrete signal line 230 to store the received data in the selected memory region.

A receiver 212 may externally receive the data storage-related signals, such as data, addresses, and commands. The receiver 212 may be an I/O device and may include one or more I/O buffers and other components for receiving and sending data storage related signals to and from a host.

A memory region selection unit 214 may analyze a received region address, select a memory region appropriate for storing data corresponding to the received region address, and selectively transmit the data storage-related signals, such as the data, the addresses, and the commands, through a signal line 230 corresponding to the selected memory region. In some embodiments, the memory region selection unit 214 may include a memory that stores information relating to each of the plurality of memory regions 120. In some embodiments, the memory region selection unit 214 may include circuitry to analyze a received region address to determine to which memory region it should send the received data and accompanying signals such that the received data would be stored in that memory region. In some embodiments, the memory region selection unit 214 is similar to the memory region selector 114.

The memory region 220, which receives the data storage-related signals through a corresponding signal line 230, may store the data using the data storage-related signals, such as the data, the addresses, and commands, which may be transmitted through the signal line 230 using the controller 222. The controller 222 may function in a manner similar to the controller 122.

Since the plurality of memory regions 220 are the same as the memory regions 120 of FIG. 1, a description thereof will be omitted.

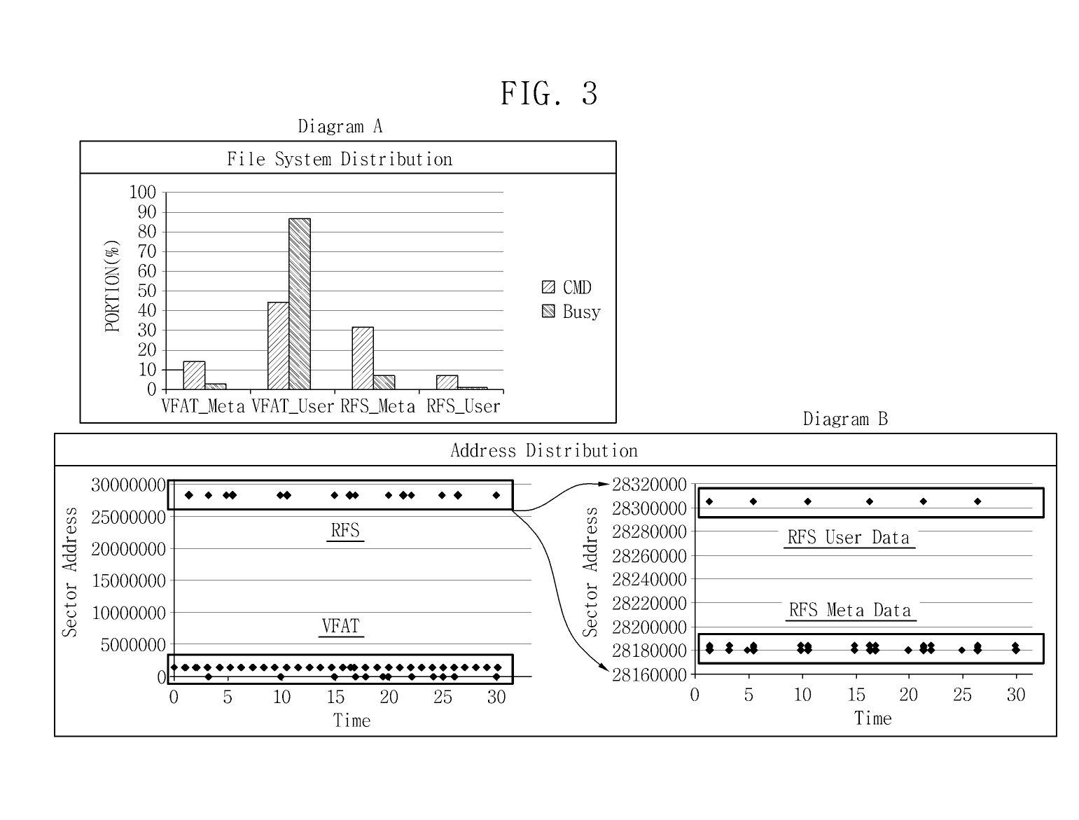

FIG. 3 is a diagram for explaining the distinction between received region addresses according to the type of data and/or type of file system of the data by which the data is processed according to embodiments of the disclosure.

FIG. 3 includes diagrams to help understand the disclosure. For example, Diagram A shows distribution characteristics of each file system of a host apparatus. In Diagram A, respective file systems (such as a VFAT and RFS) and respective data (such as meta data (i.e., random data) and user data (i.e., sequential data)) may have different busy characteristics. It may be beneficial to select memory regions 220 to store the data having the different characteristics such that each memory region 220 is configured to process specific data that is distinguished from one another due to differences in the busy characteristics.

Diagram B shows distribution characteristics of sector addresses generated according to both the respective file systems processing the data to be stored and the types of data to be stored from the host apparatus. In some embodiments, the sector addresses may be sent by the host and may be the received region addresses received by the receivers 112, 212.

The address regions may be first largely divided according to the type of a file system that processes the data to be stored and also divided according to the type of data to be stored (e.g., meta data or user data) in the address regions of the same file system.

In the present disclosure, a memory region may be optimized to store data affiliated with a specific sector address region.

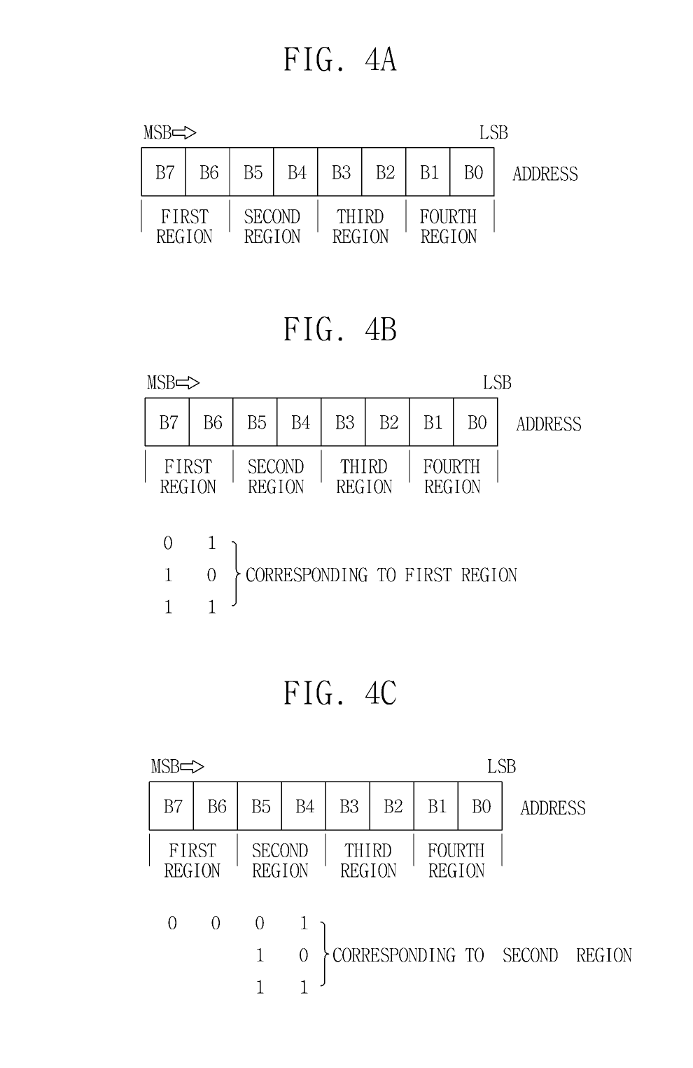

FIG. 4A is a diagram for explaining an example operation of selecting a memory region using a received region address in a memory region selection unit according to embodiments of the disclosure. In some embodiments, the memory region selection unit may be memory region selector 114 or memory region selection unit 214.

In some embodiments, the received region address includes 8 bits. In some embodiments, there may be four memory regions at which data may be stored, based on the type of data to be stored (random metadata or sequential user data) and the file system that processes the data (VFAT or RFS). The data to be stored may belong to any one of first through fourth regions based on the bit digits of the address.

In other embodiments, an 8 bit address may indicate anywhere from 1 to 256 regions, and the memory regions may be optimized over up to 8 characteristics of the received data. For example, if the memory regions are optimized over 3 characteristics, the region address may be 3 bits or any other higher number of bits. When the memory regions are optimized over N characteristics (where N is a positive integer), the region address may be at least N bits and may include more than N bits. A region address of N bits may indicate up to 2^{N} regions.

In some embodiments, the data may have two or more characteristics. For example, characteristics may include, but are not limited to, type of data (including sequential or random, multimedia or non-multimedia, etc.), file system by which data was processed, size of data, speed at which data is received by the host, whether the data is encrypted or to be encrypted, and so forth. There may be at least as many memory regions as data characteristics. In some embodiments, each memory region is optimized over all of the characteristics of data. In some embodiments, each memory region may be optimized over one or more of the characteristics of the data. The memory region selection unit may choose a memory region based on one or more of the characteristics of the data. For example, the memory region selection unit may choose a memory region based on two characteristics of the data, all of the characteristics of the data, or some other number of characteristics of the data. In some embodiments, the received region address may indicate the presence or absence of all of the characteristics of data for which the memory regions are optimized. In some embodiments, the received region address may indicate the presence or absence of only those characteristics by which the memory region selection unit selects a memory region.

In some embodiments, a memory region selection unit, which may receive a region address (as shown in FIG. 4A), may first examine the two most-significant-bit (MSB) digits of the address as shown in FIG. 4B, which may indicate that the data associated with the region address should be stored at a first region when logic 1 is present in at least one of the two bit digits. The memory region selection unit may select a corresponding memory region optimized to process the data belonging to the first region.

In an embodiment where logic 1 is not present in the first two MSB digits of the region address, the memory region selection unit may examine the next two MSB digits, as shown in FIG. 4C. In this embodiment, the next two MSB digits may indicate that the data associated with the region address should be stored at a second region when logic 1 is present in at least one of these two bit digits. The memory region selection unit may select a corresponding memory region optimized to process the data belonging to the second region.

In an embodiment where logic 1 is not present in the first or second two MSB digits of the region address, the memory region selection unit may examine the next two MSB digits, as shown in FIG. 4D. In this embodiment, the next two MSB digits may indicate that the data associated with the region address should be stored at a third region when logic 1 is present in at least one of these two bit digits. The memory region selection unit may select a corresponding memory region optimized to process the data belonging to the third region.

In an embodiment where logic 1 is not present in the first, second, or third MSB digits of the region address, the memory region selection unit may examine the next two MSB digits, as shown in FIG. 4E. In this embodiment, the next two MSB digits may indicate that the data associated with the region address should be stored at a fourth region when logic 1 is present in at least one of these two bit digits. The memory region selection unit may select a corresponding memory region optimized to process the data belonging to the fourth region.

In these embodiments, the region determination unit 110 may sequentially test MSB digits of the address. For example, the memory region selector 114 may specify a region, select a corresponding memory region optimized to process data belonging to the specified region, and selectively enable the corresponding memory region or selectively transmit data storage-related signals to the corresponding memory region.

For example, a first memory region may be optimized to process data corresponding to a first region, a second memory region may be optimized to process data corresponding to a second region, a third memory region may be optimized to process data corresponding to a third region, and a fourth memory region may be optimized to process data corresponding to a fourth region.

In one example, when region address 10011010 is received, data corresponding to the received region address may correspond to the first region so that the first memory region can be selected as an optimum memory region. In another example, when region address 00001011 is received, data corresponding to the received region address may correspond to the third region so that the third memory region can be selected as an optimum memory region.

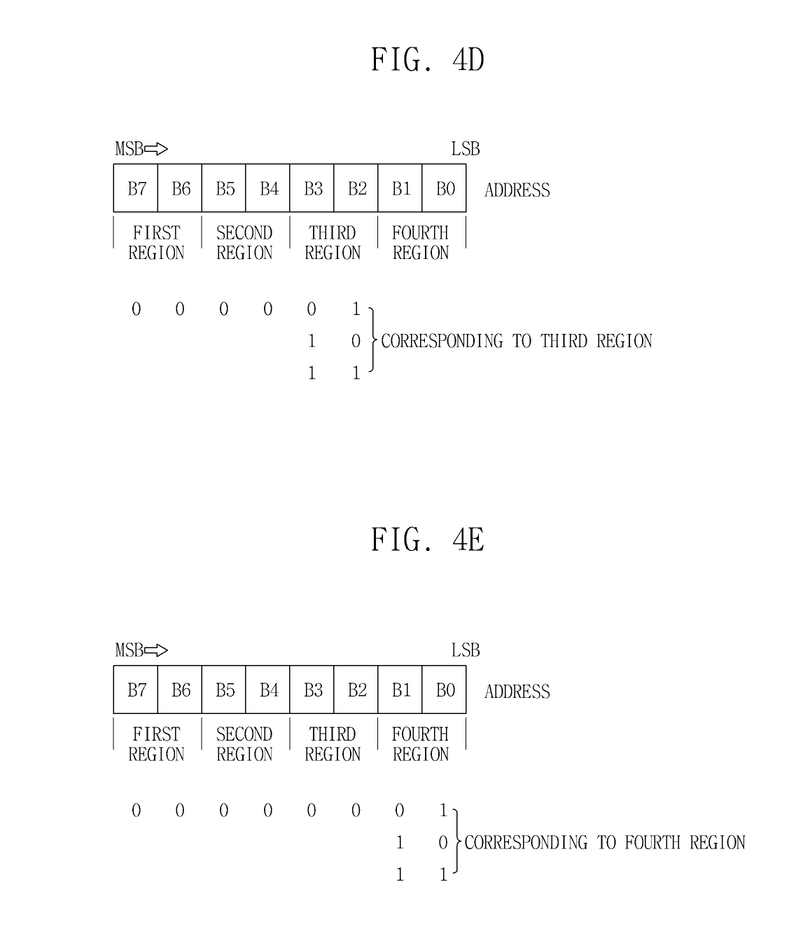

FIGS. 5A and 5B are diagrams for explaining another example of the operation of selecting the memory region using the region address in the memory region selection unit according to the embodiments of the disclosure.

FIG. 5A illustrates a fusing circuit configured to determine to which region a region address corresponding to received data belongs.

As described above with reference to FIGS. 4A-4E, in these embodiments, a region address includes 8 bits and may indicate four regions.

In these embodiments where the region address indicates four regions, the two MSB digits of the region address may be examined first. Two bits B7 and B6 may be respectively applied to an OR logic gate G1 and a NOR logic gate G2, and outputs of the two logic gates G1 and G2 may be applied to an OR logic gate GR1.

The outputs of the logic gates G1, G2, and GR1 may be respectively connected in series to MOS transistors N1, N2, and NR1 and fuses F1, F2, and FR1, and one end of each of the fuses F1, F2, and FR1 may be connected in parallel to an operation enable transistor M1 and an AND gate G10.

Each of the MOS transistors N1, N2, and NR1 and the operation enable transistor M1 may be an NMOS transistor.

The two next MSB digits may be examined next. Two bits B5 and B4 may be respectively applied to an OR logic gate G3 and an NOR logic gate G4, and outputs of the two logic gates G3 and G4 may be applied to an OR logic gate GR2.

The outputs of the logic gates G3, G4, and GR2 may be respectively connected in series to MOS transistors N3, N4, and NR2 and fuses F3, F4, and FR2, and one end of each of the fuses F3, F4, and FR2 may be connected in parallel to an operation enable transistor M2 and the AND gate G10.

Similarly, a fusing circuit corresponding to bits B3 and B2 (and the third region) and a fusing circuit corresponding to bits B1 and B0 (and the fourth region) may be connected in like manners.

When an active signal ACT is enabled, MOS transistors may be turned on, and operation enable transistors may be turned off. The outputs of the fuses F1, F2, FR1, F3, F4. FR2. F5. F6. FR3. F7, F8, and FR4 may be transmitted to the AND gate G10.

The fusing circuit may be formed in a larger or smaller size, for example, in a number equal to that of the plurality of memory regions, and an output signal Sout of the AND gate G10 of each of the fusing circuits may be an enable signal for selectively enabling a corresponding memory region or a switching signal for controlling selective transmission of data storage-related signals to a corresponding memory region.

The table of FIG. 5B shows exemplary fusing states of fusing circuits corresponding to the respective regions. In the table, O denotes an uncut state, while X denotes a cut state.

In one example of a fusing circuit configured to determine data belonging to a first region, fuses other than fuses F1, FR2, FR3, and FR4 may be cut.

When logic 1 is present in either of bits B7 and B6, an output signal Sout may be a logic-1 enable signal or switching signal corresponding to the first region, so that a first memory region configured to process the data belonging to the first region may be selectively enabled or selectively receive data storage-related signals.

In one example of a fusing circuit configured to determine data belonging to a second region, fuses other than fuses F2, F3, FR3, and FR4 may be cut.

When logic 0 is present in each of the bits B7 and B6 and logic 1 is present in either of bits B5 and B4, the output signal Sout may be a logic-1 enable signal or switching signal corresponding to the second region, so that a second memory region configured to process the data belonging to the second region may be selectively enabled or selectively receive data storage-related signals.

In one example of a fusing circuit configured to determine data belonging to a third region, fuses other than fuses F2, F4, F5, and FR4 may be cut.

When logic 0 is present in each of the bits B4, B5, B6, and B7, and logic 1 is present in either of bits B3 and B2, the output signal Sout may be a logic-1 enable signal or switching signal corresponding to the third region, so that a third memory region configured to process the data belonging to the third region may be selectively enabled or selectively receive data storage-related signals.

In one example of a fusing circuit configured to determine data belonging to a fourth region, fuses other than fuses F2, F4, F6, and F7 may be cut.

When logic 0 is present in each of the bits B2, B3, B4, B5, B6, and B7, and logic 1 is present in either of the bits B1 and B0, the output signal Sout may be a logic-1 enable signal or switching signal corresponding to the fourth region, so that a fourth memory region configured to process the data belonging to the fourth region may be selectively enabled or selectively receive data storage-related signals.

For example, when an address 10011010 is received, the address may be applied to each of the fusing circuits corresponding to the first through fourth regions, in an embodiment in which memory regions are optimized over two characteristics.

In this case, the fusing circuit of the first region may output a logic-1 output signal Sout because each of fuse output lines F01, F02, F03, and F04 is logic 1. On the other hand, the fusing circuit of the second region may output a logic-0 output signal Sout because fuse output line F01 is logic 0 and each of fuse output lines F02, F03, and F04 is logic 1, the fusing circuit of the third region may output a logic-0 output signal Sout because each of fuse output lines F01 and F02 is logic 0 and each of fuse output lines F03 and F04 is logic 1, and the fusing circuit of the fourth region may output a logic-0 output signal Sout because each of fuse output lines F01, F02, and F03 is logic 0 and fuse output line F04 is logic 1. When the fusing circuit of the first region outputs a logic-1 output signal Sout corresponding to the first region, the memory region selection unit sends data-related storage signals to the first memory region. In some embodiments, the memory region selection unit stores data associating the regions corresponding to the fuse circuits to the memory regions of the memory.

In another example, when an address 00001011 is received, the address may be applied to each of the fusing circuits of the first through fourth regions.

In this case, the fusing circuit of the first region may output a logic-0 output signal Sout corresponding to the first region because fuse output line F01 is logic 0, and the fusing circuit of the second region may output a logic-0 output signal Sout corresponding to the second region because fuse output line F02 is logic 0, the fusing circuit of the fourth region may output a logic-0 output signal Sout corresponding to the fourth region because fuse output line F03 is logic 0. On the other hand, the fusing circuit of the third region may output a logic-1 output signal Sout corresponding to the third region because each of fuse output lines F01, F02, F03 and F04 are logic-1. In this example, the memory region selection unit may send data-related storage signals to the third memory region associated with the third region.

Other circuits may be used to examine a received region address and determine a region based on the address. For example, various types of fuses circuits or non-fuse circuits may be used.

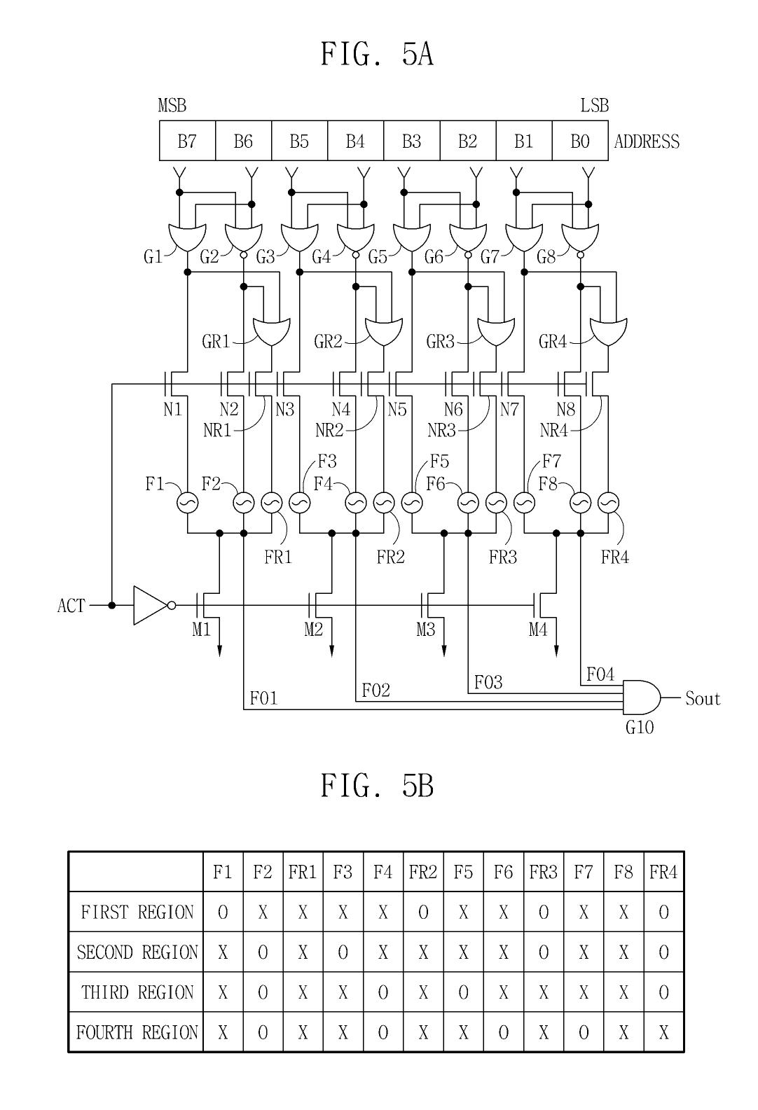

FIG. 6 is a block construction diagram of a memory system according to embodiments of the disclosure.

A host apparatus 10 may generate data storage-related signals, such as data DATA to be stored, an address ADD, and a command CMD, and transmit the data storage-related signals through a signal line 12 to a memory device 20.

The memory device 20 may select a corresponding memory region to store the data DATA using the received address ADD and may store the corresponding data DATA in the selected memory region.

The host apparatus 10 may divide the data DATA to be stored according to the type of a file system by which data is processed and/or according to the type of data and generate the address ADD.

The host apparatus 10 may include an apparatus including a computing device (e.g., a mobile device such as a portable phone or a smart phone) in which data is processed by a processor.

The memory device 20 may be one of memory devices 100 and 200. Accordingly, a detailed description of the memory device 20 will be omitted. For example, the memory device 20 may include a region determination unit and a plurality of memory regions.

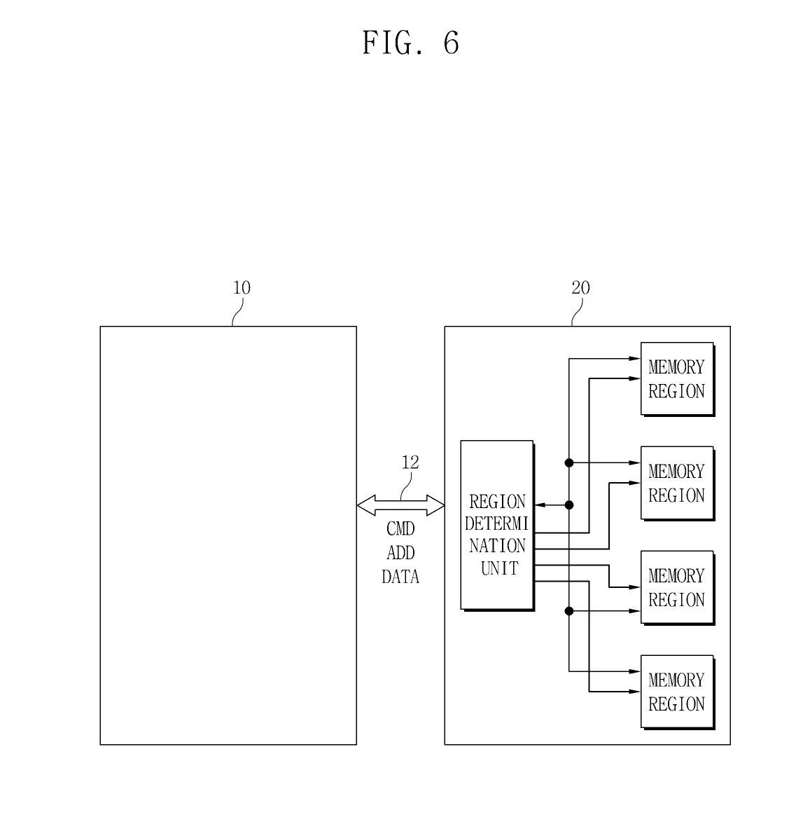

FIG. 7 is a block construction diagram of a memory system according to other embodiments of the disclosure.

In an example memory system of FIG. 7, a region determination unit 420 is included in a host apparatus 400 instead of a memory device 500.

The host apparatus 400 may include a processor 410 and the region determination unit 420 configured to receive data storage-related signals, such as data, an address, and a command, which are generated by the processor.

The region determination unit 420 may receive the data storage-related signals, such as the data, the address, and the command, from the processor 410, select a memory region appropriate for storing received data out of a plurality of memory regions of the memory device 500, and store the received data at the selected memory region.

The region determination unit 420 may transmit an enable signal to the corresponding memory region of the memory device 500 through a discrete enable signal line 450 to selectively enabling the selected memory region, and may transmit the data storage-related signals through a signal line 460.

The memory device 500 may provide the enable signal and the data storage-related signals through an interface (i.e. an I/O interface or a controller) associated with each respective memory region.

In other embodiments, the region determination unit 420 may transmit the data storage-related signals only to the selected memory region through a signal line discretely connected to the memory region instead of the enable signal line 450.

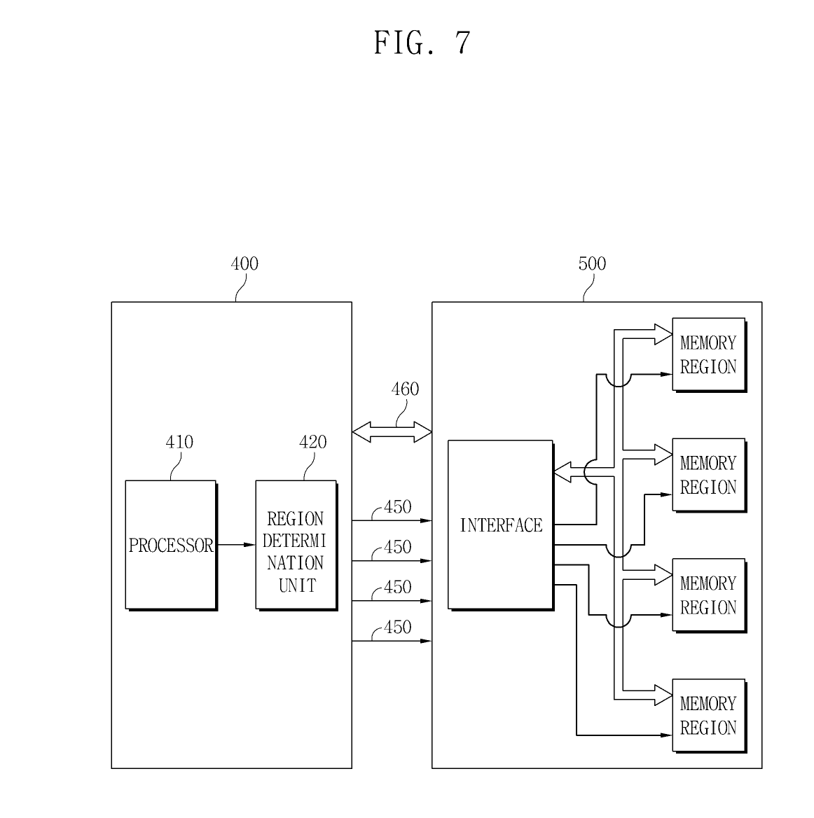

FIG. 8 is a flowchart illustrating a method of storing data in a memory region optimized to store specific data, according to embodiments of the disclosure.

In some embodiments, data storage-related signals, such as data, an address, and a command, may be received by a memory device (operation S810).

A memory region appropriate for storing data corresponding to the address may be selected out of a plurality of memory regions using the received address (operation S812).

In operation S812, a memory region may be selected after an examination of the received address. For example, while sequentially examining MSB digits of the received address, a memory region corresponding to the first MSB digit where logic 1 is present may be selected.

In another example, the address may be applied to a plurality of fusing circuits corresponding respectively to the plurality of memory regions, and a memory region corresponding to a fusing circuit in which the address satisfies a fusing state may be selected.

In another example, the memory region may be selected using any of the example methods described above.

The selected memory region may be selectively enabled, and the data storage-related signals may be transmitted to the plurality of memory regions (operation S814).

The received data may be stored in a memory cell array using the received data storage-related signals in the selected memory region (operation S816).

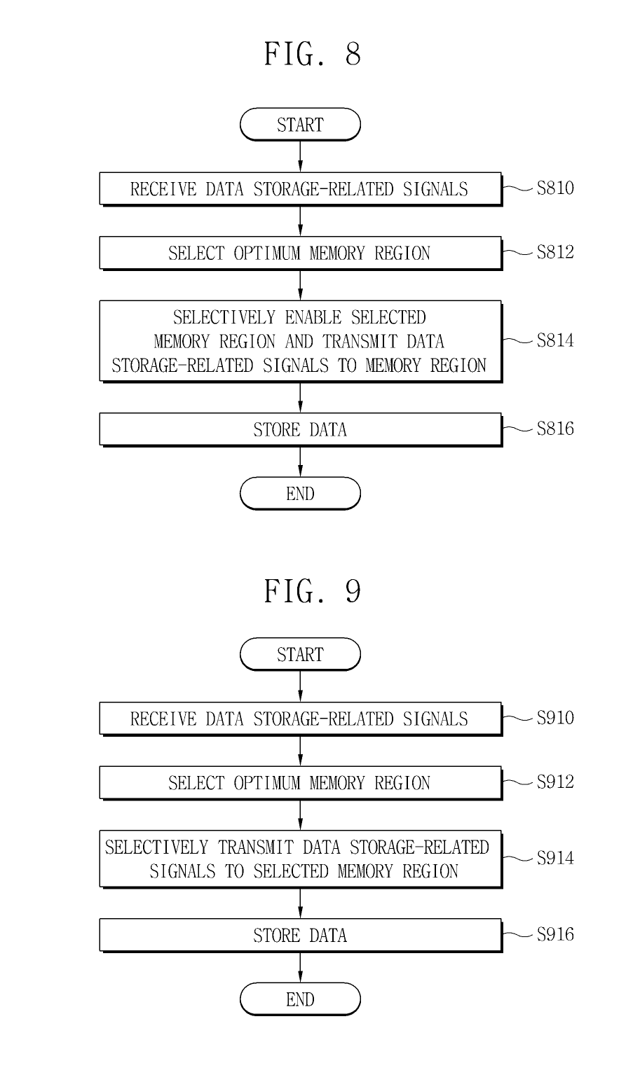

FIG. 9 is a flowchart illustrating a method of storing data in a memory region optimized to store specific data according to other embodiments of the disclosure.

In some embodiments, data storage-related signals, such as data, an address, and a command, may be received by a memory device (operation S910).

Next, a memory region appropriate for storing data corresponding to the address may be selected out of the plurality of memory regions using the received address (operation S912).

In operation S912, a memory region may be selected after an examination of the received address. For example, while sequentially examining MSB digits t of the received address, a memory region corresponding to the first MSB digit where logic 1 is present may be selected. In another example, the address may be applied to a plurality of fusing circuits corresponding respectively to the plurality of memory regions, and a memory region corresponding to a fusing circuit in which the address satisfies a fusing state may be selected. In another example, the memory region may be selected using any of the other exemplary methods described above.

The data storage-related signals may then be selectively transmitted to the selected memory region (operation S914).

Then, data may be stored in a memory cell array using the received data storage-related signals in the selected memory region (operation S916).

Embodiments of the disclosure may be applied to a memory device and a system including the same.

According to the embodiments of the disclosure, the corresponding data may be stored in a memory region optimized in terms of storage performance according to the type of data to be stored, thereby preventing performance degradation of a memory device.

The above-disclosed subject matter is to be considered illustrative and not restrictive, and the appended claims are intended to cover all such modifications, enhancements, and other embodiments, which fall within the true spirit and scope of the disclosed embodiments. Thus, the invention is to be construed by the broadest permissible interpretation of the following claims and their equivalents, and shall not be restricted or limited by the foregoing detailed description.

What is claimed is:

1. A method of storing data in a memory device, comprising:
receiving information comprising a command, an address, and data from an external source, the information having a first characteristic and at least a second characteristic;
selecting one of a plurality of memory regions for storing the received data, wherein the selecting is responsive to a determination that the information has the first characteristic and the second characteristic; and
storing the received data in the selected memory region.

2. The method of claim 1, wherein the address of the information is generated in response to the first characteristic and the second characteristic.

3. The method of claim 1, wherein at least one of the first characteristic and the second characteristic may be determined from the address of the information received.

4. The method of claim 1,
wherein the step of receiving a command, an address, and data comprises receiving by a device controller from an external source, and
wherein the step of storing the received data in the selected memory region further comprises:
sending, by the device controller, an enable signal to the selected memory region, the enable signal being unique to the selected memory region; and
sending, by the device controller, the data to at least the selected memory region.

5. The method of claim 1,
wherein the selected memory region includes a memory controller, memory cell array, and firmware to store the data,
wherein the step of storing the received data in the selected memory region further comprises:
receiving, by a memory controller of the selected memory region, the command, the address, and the data;
generating, by the memory controller, a control signal to store the data at a physical address in a memory cell array.

6. The method of claim 5, wherein the firmware is a flash translation layer (FTL), and the memory cell array is a NAND memory.

7. The method of claim 1, wherein the first characteristic is one of user data and meta data.

8. The method of claim 1, wherein the second characteristic is one of an RFS file system and a VFAT file system.

9. A memory device, comprising:
a controller configured to receive information comprising a command, an address, and data from an external source, the information having a first characteristic and at least a second characteristic;
a plurality of memory regions configured to store the data of the information, one or more of the plurality of memory regions being different from one or more of the other memory regions;
wherein the controller is further configured to select one of the plurality of memory regions for storing the received data responsive to a determination that the information has the first characteristic and the second characteristic.

10. The device of claim 9, wherein each memory region comprises:
a memory cell array configured to store data;
a region controller configured to receive the command, the address and the data from the controller and generate a control signal to store the data at physical addresses of the memory cell array; and
firmware configured to store data having at least the first characteristic and the second characteristic.

11. The device of claim 9, wherein the firmware is a flash translation layer (FTL), and the memory cell array is a NAND memory.

12. The device of claim 9, further comprising a plurality of enable signal lines between the controller and the plurality of memory regions, each enable signal line being unique to a respective memory region.

13. The device of claim 9, wherein the first characteristic is one of sequential data and random data.

14. The device of claim 9, wherein the second characteristic is one of an RFS file system and a VFAT file system.

15. The device of claim 9, wherein the controller is further configured to determine at least one of the first characteristic and the second characteristic from the address of the information received.

16. The device of claim 15,
wherein the controller is configured to store a plurality of associations, each association comprising a first characteristic and at least a second characteristic of a respective memory region,
wherein the controller is further configured to select one of the plurality of memory regions for storing the received data responsive to the stored associations.

17. A method of storing data in a memory device, comprising:
receiving information comprising a command, an address, and data, the information having a first characteristic and at least a second characteristic;
determining, from the address of the information, at least one of the first characteristic and second characteristic of the data;
selecting one of a plurality of memory regions of the memory device for storing the received data, wherein the selecting is responsive to the determination that the information has at least one of the first characteristic and the second characteristic; and
storing the data in the selected memory region.

18. The method of claim 17,
wherein the step of receiving a command, an address, and data comprises receiving by a controller residing in a host external to the memory device, and
wherein the step of storing the received data in the selected memory region further comprises:
sending, by the controller, an enable signal to the selected memory region in the memory device; and
sending, by the controller, the command, the address, and the data to at least the selected memory region.

19. The method of claim 17,
wherein the selected memory region includes a memory controller, memory cell array, and firmware to store the data,
wherein the step of storing the received data in the selected memory region further comprises:
receiving, by a memory controller of the selected memory region, the command, the address, and the data;
generating, by the memory controller, a control signal to store the data at a physical address in a memory cell array.

20. The method of claim 17, wherein the first characteristic is a type of the data, and the second characteristic is a type of file system used to process the data.
